(19) United States
(12) Patent Application Publication
(10) Pub. No.: US 2004/0238341 A1
(43) Pub. Date: Dec. 2, 2004

(54) Tact switch

(76) Inventors: Wei Yu, Shenzhen (CN); Yong Hui Hu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/859,367

(22) Filed: Jun. 1, 2004

(30) Foreign Application Priority Data
May 30, 2003 (TW) 92210057

(51) Int. Cl. H01H 5/00

(52) U.S. Cl. 200/402

(57) ABSTRACT

A tact switch (1) includes a housing (10), a plurality of fixed contacts (20) retained to the housing, a movable contact (30), an actuator (40), a pivot piece (50) and a top cover (60) mounted onto the housing. The top cover has at least one support arm (64). The movable contact is positioned between the fixed contacts and the top cover. The actuator has an operating portion (42) and a press portion (44). The pivot piece pivotably mounted to the at least one support arm of top cover has an engaging portion (52) engaging with the press portion of the actuator. When the operating portion is pressed, the press portion depresses the engaging portion to deflect the engaging portion downwardly to depress the movable contact, and the movable contact elastically deforms downwardly to electrically connect the plurality of fixed contacts to each other.

### BACKGROUND OF THE INVENTION

1. Field of the Invention

The present invention relates to an electrical switch, and particularly to a tact switch which needs a manual depression and the depression can produce electrical connection between a plurality of separate contacts.

2. Description of Prior Art

Tact switches which quickly respond to a manual depression have been used in many appliances, such as in telephone sets, microwaves, remote controls, and TV sets.

JP Pat. No. 2572590 discloses an electrical switch which includes a housing, a plurality of contacts retained in the housing, a metal dome lying over the plurality of contacts, an actuator arrangement and a cover with an oblique plate. The actuator arrangement includes a press section positioned between the cover and the metal dome and a manipulating section extending to external side of the housing. In operation, when the manipulating section of the actuator arrangement is pressed by a user, the press section of the actuator arrangement moves forwardly and engages with the oblique plate, at the same time the oblique plate drives the press section downwardly to depress a middle portion of the metal dome so that the metal dome simultaneously electrically connects the plurality of contacts to each other. However, after a period of use, the oblique plate of the cover could be elastically deformed through enough cycles so it would fail through metal fatigue, which makes the metal dome fail to deform downwardly to contact with the contacts so that the electrical switch loses its function.

U.S. Pat. No. 5,660,272 discloses another electrical switch which includes a housing, a plurality of contacts retained in the housing, a tripping member lying over the plurality of contacts, an actuator arrangement and a cover. The actuator arrangement includes a sheet metal force transfer member with a horizontal plate and with a deflectable strip or lever, and an actuator device or pusher with a ramp that can engage the lever to deflect it. Horizontal forward movement of the pusher deflects the front of the lever downwardly, to depress the middle portion of the tripping member. However, the structure of the force transfer member is complex so that it is difficult to manufacture. Moreover, after a period of use, the lever of the force transfer member could be elastically deformed through enough cycles so it would fail through metal fatigue, which makes the tripping member fail to deform downwardly to connect with the fixed contacts so the electrical switch loses its function.

Hence, an improved tact switch is desired to overcome the disadvantages of the prior art.

### BRIEF SUMMARY OF THE INVENTION

A main object of the present invention is to provide a tact switch providing a reliable electrical connection between a plurality of fixed contacts.

Another object of the present invention is to provide a tact switch having a simple structure.

A tact switch in accordance with the present invention comprises a housing having a bottom wall, a plurality of fixed contacts retained in the bottom wall of the housing, a movable contact, an actuator, a pivot piece engaging with the actuator and a top cover mounted onto a top surface of the housing. The top cover has at least one support arm with an arc-shaped portion. The movable contact is positioned between the fixed contacts and the top cover. The actuator has an operating portion extending to external side of the housing and a press portion positioned between the cover and the movable contact The pivot piece has a columned pivot portion disposed on arc-shaped portion and an engaging portion engaging with the press portion of the actuator.

In operation, when the actuator is pressed inwardly, the press portion of the actuator depresses the engaging portion of the pivot piece to deflect the engaging portion downwardly to depress the movable contact, and the movable contact elastically deforms downwardly to electrically connect the plurality of fixed contacts to each other, achieving an electrical connection between the plurality of fixed contacts.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an exploded view of a tact switch in accordance with the present invention.

FIG. 2 is another exploded view of the tact switch of FIG. 1.

FIG. 3 is an assembled view of the tact switch of FIG. 1.

FIG. 4 is a schematic, cross-sectional view taken along line 4-4 of FIG. 3 showing a movable contact before being deformed.

FIG. 5 is a schematic view showing the movable contact of FIG. 4 deformed.

### DETAILED DESCRIPTION OF THE INVENTION

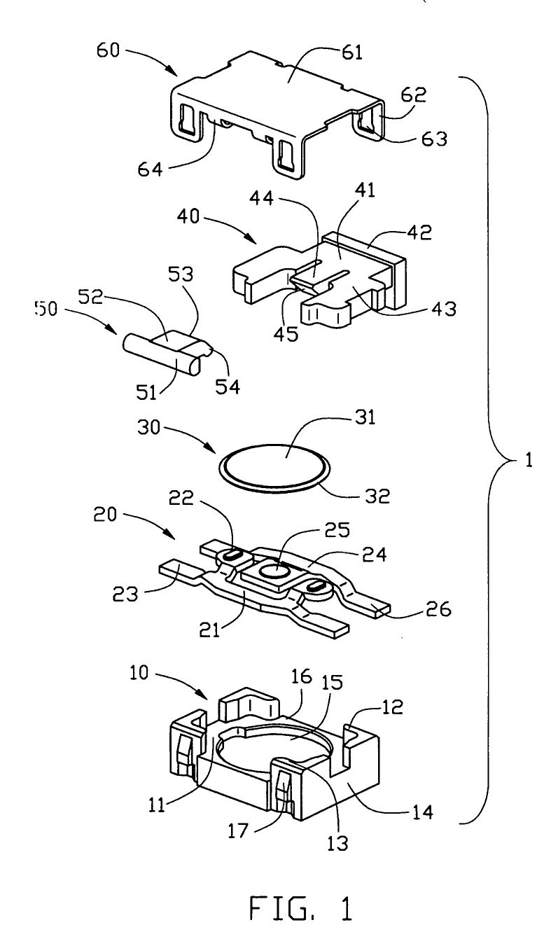

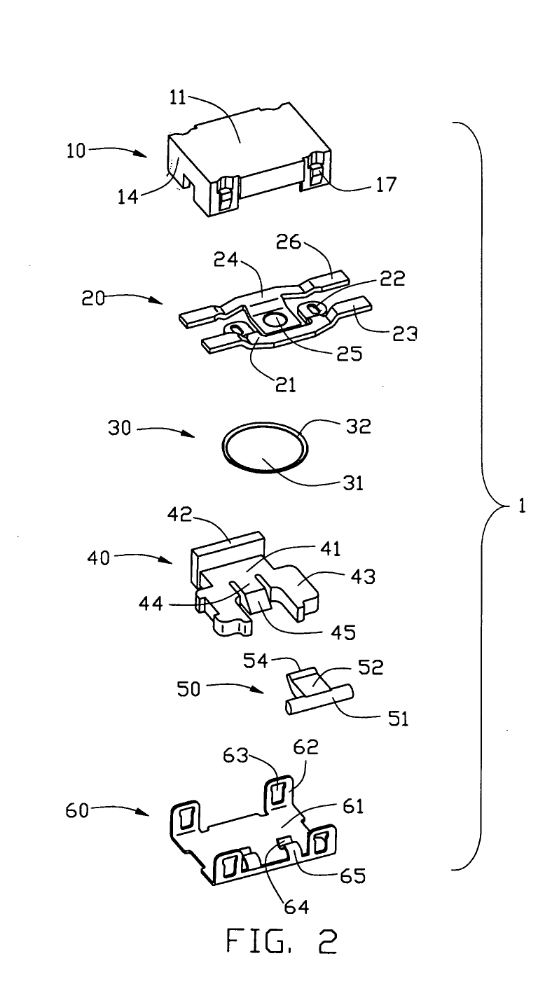

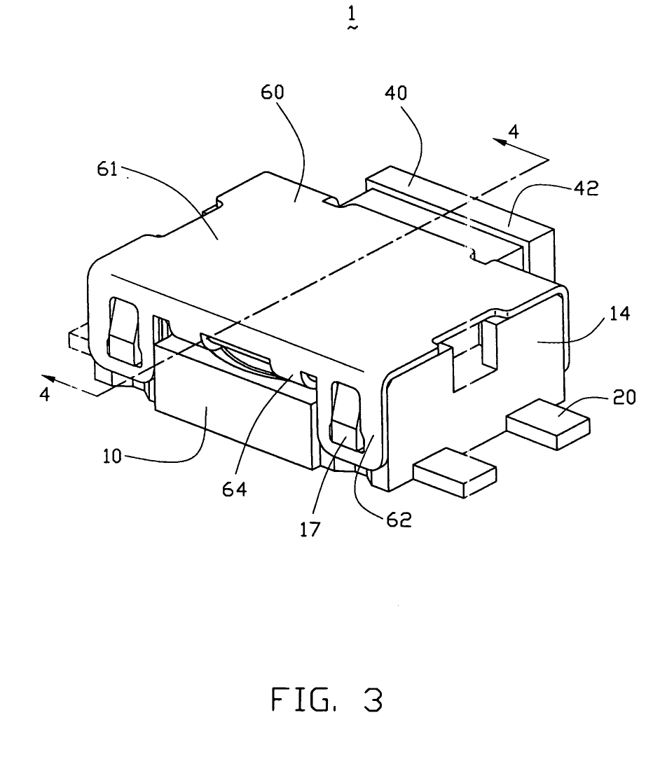

Referring to FIGS. 1, 2 and 3, a tact switch 1 in accordance with the present invention comprises a housing 10, a plurality of fixed contacts 20 retained in the housing 10, a movable contact 30, an actuator 40, a pivot piece 50 and a top cover 60.

The housing 10 has a bottom wall 11 and peripheral walls (not labeled) which extends upwardly from side edges (not labeled) of the bottom wall 11. A receiving space (not labeled) is defined within the housing 10 by the bottom wall 61 and the peripheral walls. The peripheral walls include a front wall 12, a rear wall 13 and opposite side walls 14. A substantially circular cavity 15 is defined in the bottom wall 11. A pair of entrances 16 are respectively defined in middle portions of the front wall 12 and the rear wall 13. Four protrusions 17 are defined in outward sides of the front and rear walls 12, 13 and are adjacent to the two side walls 14.

The plurality of fixed contacts 20 partially embedded in the housing 10 by insert molding include a first contact 21 and a second contact 24. The first contact 21 includes a first contact portion 22 exposed to the cavity 15 and a first solder portion 23 extending out of the housing 10 for soldering to a printed circuit board of an electrical device (not shown). The second contact 24 includes a second contact portion 25 exposed to the cavity 15 and a second solder portion 26 extending out of the housing 10 for soldering to the printed circuit board.

The movable contact 30 has a central portion 31 and a side portion 32. The actuator 40 has a body portion 41 and an operating portion 42 extending from the body portion 41. A pair of support portions 43 extend from two ends of the main body 41. A press portion 44 extends between the pair of support portions 43 with a first inclined surface 45 on a free end thereof.

The pivot piece 50 has a columned pivot portion 51 and an engaging portion 52 with a second inclined surface 53 on a free end thereof. A projection 54 projects downwardly from a bottom surface of the engaging portion 52 for mating with the movable contact 30.

The top cover 60 includes a rectangular plate 61 with a front edge (not labeled), a rear edge (not labeled) and a pair of side edges (not labeled). Four retaining plates 62 extend downwardly from the front edge and the rear edge. Each retaining plate 62 has a notch 63 for engaging with a corresponding protrusion 17 of the housing 10. A pair of support arms 64 extend between two retaining plates 62 projecting from the rear edge of the plate 61. Each support arm 64 has an arc-shaped portion 65.

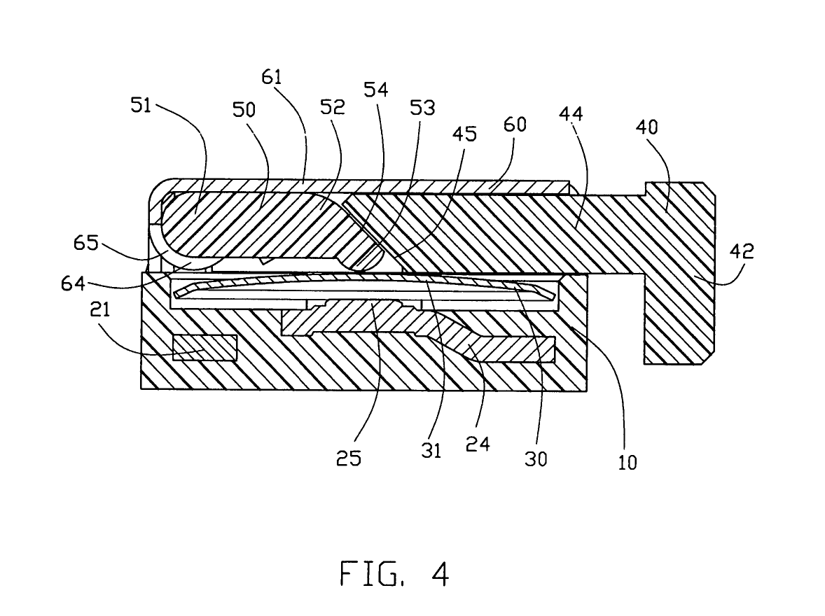

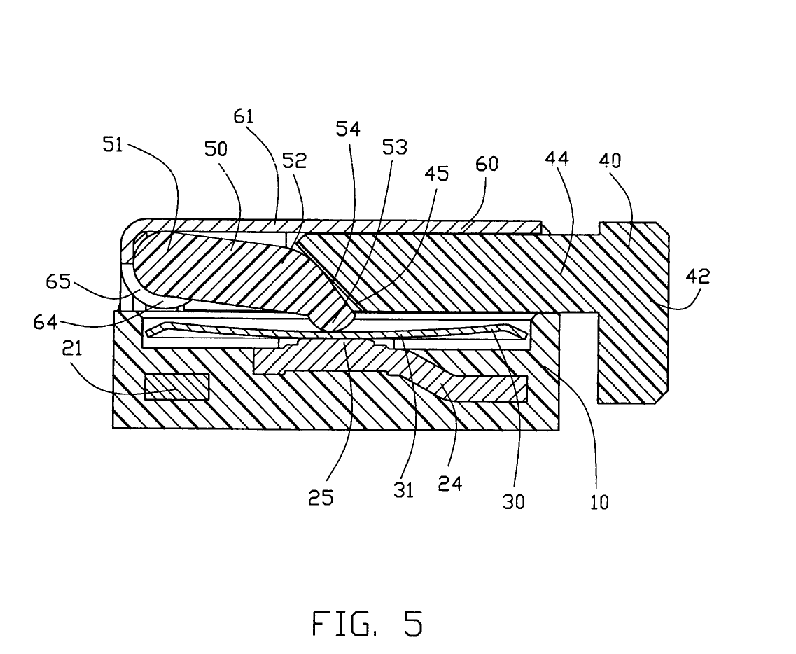

Referring to FIGS. 4 and 5, in assembly, the movable contact 30 is positioned in the cavity 15 of the housing 10 with two opposite edges thereof contacting with the first contact portion 22 of the first contact 21. The central portion 31 lies over the second contact portion 25 of the second contact 24 and remains untouched with the second contact portion 25. The actuator 40 is assembled in the housing 10 with the operating portion 42 extending out through the first entrance 16 of the housing 10 and the body portion 41 disposed in the receiving space of the housing 10. The pivot piece 50 is disposed on the arc-shaped portions 65 of the pair of support arms 64 and lay between the rectangular plate 61 and the support arms 64. The columned pivot portion 51 abuts against the arc-shaped portions 65 so that it can be deflected downwardly. The pivot piece 50 and the top cover 60 are together mounted onto a top surface of the housing 10, with each notch 64 of the retaining plate 62 engaging with the corresponding protrusion 17 of the front and rear walls 12, 13, and the second inclined surface 53 abutting against the first inclined surface 45 of the actuator 40.

In use, the operating portion 42 of the actuator 40 is pressed inwardly. The press portion 44 of the actuator 40 moves rearwardly and engages with the engaging portion 52 of the pivot piece 50, deflecting the engaging portion 52 downwardly to depress the movable contact 30 by the deflection of the columned pivot portion 51. The movable contact 30 elastically deforms downwardly to contact with the second contact portion 25 so that the movable contact 30 simultaneously electrically connects the first contact 21 and the second contact 24. When the operating portion 42 is released, the central portion 31 of the movable contact 30 recovers upwardly to press against the engaging portion 52 of the pivot piece 50. The engaging portion 52 presses against the press portion 45 of the actuator 40 and push the actuator 40 outwardly, at the same time the central portion 31 of the movable contact 30 disconnects from the second contact portion 25 of the second contact 24. Since the tact switch 1 has a pivot piece 50 engaging with the press portion 44 of the actuator 40 instead of the oblique plate of the cover of the prior art which make the connection between the plurality of fixed contacts 20 be reliable. Furthermore, the pivot piece 50 has a simple structure to manufacture.

In another embodiment of the present invention the movable contact 30 is untouched with both the first and second contact portions 22, 25 of the first and second contacts 21, 24 originally. When the operating portion 42 of the actuator 40 is pressed forwardly, the press portion 45 of the actuator 40 deflects the pivot piece 50 downwardly to depress the movable contact 30. The movable contact 30 elastically deforms downwardly to contact with the first and the second contact portions 22, 25 so that the movable contact 30 simultaneously electrically connects the first contact 21 and the second contact 24.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A tact switch comprising:
a housing;
a plurality of fixed contacts disposed in the housing;
a movable contact moveable relative to the fixed contacts;
an actuator having an operating portion and a press portion;
a top cover mounted onto the housing and having at least one support arm; and
a pivot piece lying over the movable contact and pivotably mounted to the support arm, the pivot piece having an engaging portion engaging with the press portion of the actuator; wherein
a linear movement of the actuator results in a pivotal movement of the pivot piece due to engagement between the press portion and the engaging portion, thus further making the moveable contact move toward the fixed contacts and electrically connecting said fixed contacts.

2. The tact switch as described in claim 1, wherein the top cover has a rectangular plate, and the at least one support arm projects from one edge of the plate.

3. The tact switch as described in claim 1, wherein the plate has a front edge and a rear edge, and two pairs of retaining plates respectively project downwardly from the front edge and the rear edge, and wherein the at least one support arm extends between the two retaining plates projecting from the rear edge.

4. The tact switch as described in claim 1, wherein the at least one support arm has an arc-shaped portion, and the pivot piece has a pivot portion disposed on the arc-shaped portion.

5. The tact switch as described in claim 4, wherein the pivot portion has a substantially columned shape.

6. The tact switch as described in claim 1, wherein the at least one support arm comprises a pair of support arms.

7. The tact switch as described in claim 1, wherein the engaging portion has a projection projecting from a bottom surface thereof for engaging with the movable contact.

8. The tact switch as described in claim 1, wherein the press portion has a first inclined surface on a free end thereof, and the engaging portion has a second inclined surface on a free end thereof abutting against the first inclined surface.

9. A tact switch comprising:
a housing;
a plurality of fixed contacts disposed in the housing;
a movable contact moveable relative to the fixed contacts;
an actuator having an operating portion and a press portion;
a metallic top cover mounted onto the housing and covering interior of the housing;
a support arm integrally formed from the top cover and located in the housing; and
a pivot piece lying over the movable contact and pivotably engaged with the support arm, the pivot piece having an engaging portion engaging with the press portion of the actuator; wherein
a linear movement of the actuator results in a pivotal movement of the pivot piece due to engagement between the press portion and the engaging portion, thus further making the moveable contact move toward the fixed contacts and electrically connecting said fixed contacts.
